(19) United States
(12) Patent Application Publication
(10) Pub. No.: US 2016/0069221 A1
(43) Pub. Date: Mar. 10, 2016

(54) THERMAL WATER TREATMENT FOR STIG POWER STATION CONCEPTS

(71) Applicant: SIEMENS AKTIENGESELLSCHAFT, München (DE)

(72) Inventors: Thomas HAMMER, Hemhofen (DE); Uwe LENK, Zwickau (DE); Alexander TREMEL, Erlangen (DE); Markus Ziegmann, Baiersdorf (DE)

(73) Assignee: SIEMENS AKTIENGESELLSCHAFT, Munich (DE)

(21) Appl. No.: 14/888,209

(22) PCT Filed: Apr. 14, 2014
(86) PCT No.: PCT/EP2014/057478

§ 371 Date: Oct. 30, 2015

(30) Foreign Application Priority Data
May 2, 2013 (DE) 10 2013 208 002.6

(51) Int. Cl. F01K 23/10; C02F 1/04; B01D 5/00; F02C 6/04

(52) U.S. Cl. CPC F01K 23/10; F02C 6/04; C02F 1/04; B01D 5/0075; C02F 2101/30

(57) ABSTRACT

A method and an assembly for thermal water treatment for STIG power station concepts. The heat of an exhaust gas after a heat recovery steam generator stage is used for treating water in a water treatment system. The heat of the exhaust gas, the gas having a low-temperature level, is transported through a heating element to water that circulates between at least one evaporator and condenser in the water treatment system. The treated process water can then be used for steam injection into the gas turbine.

### CROSS REFERENCE TO RELATED APPLICATIONS

This application is the U.S. national stage of International Application No. PCT/EP2014/057478, filed Apr. 14, 2014 and claims the benefit thereof. The International Application claims the benefit of German Application No. 102013208002.6 filed on May 2, 2013, both applications are incorporated by reference herein in their entirety.

### BACKGROUND

Described below is a method for the thermal preparation of untreated water or condensation water to give process water.

Also described below is a system of a gas turbine with steam injection, a waste heat steam generator, a heater and a water preparation plant. The system may further include at least one vaporizer and condenser.

Gas turbines are used to drive generators in electric power plants but are also used to drive propellers in jet engines, or to drive compressors or pumps. In the field of combined heat and power, gas turbines are used in order that the hot exhaust gas thereof can be used to generate heat. Gas turbines are composed of a compressor-combustor-turbine arrangement, wherein turbine refers only to the expansion part of the gas turbine. Depending on the configuration and operating conditions of the gas turbine, the exhaust gas leaving the turbine is at a temperature of between 400° C. and 650° C. According to the related art, a waste heat steam generator is connected downstream of the gas turbine in order to use the thermal energy of the exhaust gas and generate steam. The steam can be injected back into the combustion chamber of the gas turbine so as to increase the power of the gas turbine by virtue of the increased mass flow. Furthermore, the injection of steam reduces the nitrogen oxide concentration in the exhaust gas. Overall, this increases the efficiency of the gas turbine. This method is known as the STIG concept or the Cheng process. Downstream of the waste heat steam generator, the exhaust gas is typically at a low temperature of 70° C. to 200° C. in the case of a two- or three-pressure connection of the waste heat steam generator and approximately 100° C. to 250° C. in the case of a one-pressure connection. For the injection of the water into the gas turbine, high-quality water is also necessary. For water preparation in STIG concepts, the related art offers various onerous methods, wherein the effort involved is dependent on the quality of the untreated water. The most prevalent of these possible methods are ion-exchange and reverse osmosis. However, both methods have limitations in the event of high levels of pollution in the untreated water. Thus, organic pollutants lead to irreversible adsorption processes in the case of ion-exchange and to reduced flux rate in the case of reverse osmosis. In certain circumstances, therefore, further costly steps are connected upstream of both methods. A further drawback of the STIG concept is the loss of the steam and thus of the water in the exhaust gas of the gas turbine. It is thus often necessary to provide process water of the quality required for the steam injection. The STIG process is therefore not used in long-term operation but only for short-term power increases in the case of briefly raised current demand.

A method for operating a thermal water preparation in the context of STIG concepts, which makes use of the low thermal energy of an exhaust gas downstream of a waste heat steam generator, is described. A system which permits this use and avoids the above-mentioned drawbacks is also described.

### SUMMARY

In one aspect, a method for operating a thermal water preparation plant includes the following operations:
generating a first exhaust gas using a gas turbine,
using a waste heat steam generator to cool the first exhaust gas to give a second exhaust gas at a temperature of 70° C. to 250° C.,
supplying a first warm water from a condenser to a vaporizer within the water preparation plant,
feeding the second exhaust gas to a heater to pass on the exhaust gas heat to the first warm water.

The method permits use of the heat of a second exhaust gas downstream of the waste heat steam generator in a water preparation plant, for example for the preparation of untreated water or condensation water to give process water. The water preparation plant may be operated according to the principle of convection-supported vaporization of water in a vaporizer in counter-flowing air combined with water-cooled condensers for condensing out the clean process water while at the same time recovering the vaporization heat. Therefore, the water preparation plant has at least one condenser and vaporizer. The water preparation plant is operated in combination with a gas turbine which generates a first exhaust gas at a temperature in the range from 400° C. to 650° C. In this context, the gas turbine can be a gas turbine with steam injection. Then, the first exhaust gas generated by the gas turbine is cooled using the waste heat steam generator to a low temperature of 70° C. to 250° C. The waste heat steam generator generates steam in the process. A second exhaust gas, which corresponds to the first exhaust gas cooled in the waste heat steam generator and is at a low temperature in the range from 70° C. to 250° C., is then fed to a heater in the water preparation plant. Use of the waste heat of the second exhaust gas is achieved using the heater, which passes on the heat of the exhaust gas to a first warm water in a circuit between the vaporizer and the condenser. The heater can in particular take the form of a heat exchanger.

The low waste heat of the second exhaust gas may be sufficient for the operation of a water preparation plant of the type mentioned. It is possible for several of such water preparation plants to be connected in series or for these to be of multi-stage design. This reduces the temperature differences, which leads to higher efficiency.

The system includes a gas turbine with steam injection, a waste heat steam generator, a heater and a water preparation plant having at least one condenser and vaporizer. It is designed for carrying out the above-described method.

In one embodiment, the water preparation plant is operated according to the principle of convection-supported vaporization of water in a vaporizer in counter-flowing air combined with water-cooled condensers for condensing out the clean process water while at the same time recovering the vaporization heat.

Advantageous embodiments and refinements of the water preparation for STIG power plant concepts are presented in the subclaims. According to these, the method can have the following additional operations:

The water preparation plant can include a cooler which is operated with a first coolant, in particular with cooling water. If the water preparation plant is operated according to the principle of convection-supported vaporization of water in a vaporizer in counter-flowing air combined with water-cooled condensers for condensing out process water, it is expedient to cool the water circuit of the water preparation plant. This makes it possible for the water preparation plant to be in permanent operation since a second warm water must be cooled for use as cooling water in the condenser. The vaporization heat may be recovered simultaneously.

In one embodiment, the second coolant which is used for cooling in the exhaust gas condenser is subsequently used as coolant in the cooler. In other words, the first and second coolants are one and the same. This keeps the construction of the plant as a whole simple since the number of components is reduced. The temperature spread of the coolant is also increased, thus increasing the specific heat content per unit of flow-through quantity.

In an embodiment, it is possible for a third exhaust gas to be further cooled downstream of the heater in at least one exhaust gas condenser, using a second coolant such as cooling water. This causes steam in the third exhaust gas to condense to give a second condensation water. For example, cooling as far as 5° C. is expedient. The third exhaust gas may be cooled to below its saturation temperature.

In one embodiment, the first coolant which is used for cooling in the cooler is subsequently used as coolant in the exhaust gas condenser. This reduces the number of components. The resulting temperature spread of the coolant also causes an increase in the specific heat content per unit of flow-through quantity.

Untreated water or first condensation water from the heater or second condensation water from the exhaust gas condenser is prepared in the water preparation plant to give process water. Using the waste heat of the second exhaust gas downstream of the waste heat steam generator by the heater for operating the water preparation plant reduces the temperature of the second exhaust gas and condensation of water can take place. It is expedient to prepare this first condensation water in the water preparation plant. This recovers water which is for example injected as steam into the gas turbine. It is also possible to obtain water produced during combustion of the fuel in the gas turbine. A second condensation water can be obtained using the exhaust gas condenser. A third exhaust gas, which corresponds to the second exhaust gas cooled in the heater, is directed to the exhaust gas condenser in which condensation of at least part of the remaining steam present in the exhaust gas takes place. The second condensation water obtained using the exhaust gas condenser can subsequently be prepared in the water preparation plant to give more process water. It is also possible to use a plurality of exhaust gas condensers.

In an embodiment, the waste heat steam generator can be used to generate steam from part of the process water. When demand for current is low, the steam may be used as a heat delivery medium to supply buildings or as process steam in industry. This increases the efficiency of the plant as a whole.

At least part of the steam generated in the waste heat steam generator can be injected into the gas turbine. This has the effect of increasing the power and also the efficiency of the gas turbine with respect to the quantity of fuel used. The water or steam requirement which arises as a consequence of operating the gas turbine with steam injection can be entirely satisfied since the water in the exhaust gas is recovered.

In one embodiment, the first or second condensation water is cleaned of volatile materials or further contaminants prior to preparation in the water preparation plant, or is prepared in a treatment plant. Treatment after the preparation in the water preparation plant can also be expedient. In particular, the condensation water which is obtained from the exhaust gas of the gas turbine can contain nitric acid or sulphuric acid, with the result that these chemical materials accumulate in the process water. Contamination with organic acids, in particular with ethanoic acid or carbonic acid, is also possible. This can lead to corrosion in downstream components, in particular in the gas turbine.

Condensation in the condenser or vaporization in the vaporizer of the water preparation plant can be carried out in a plurality of operations. This reduces the temperature differences, which leads to higher efficiency. A multi-stage embodiment with a common water circuit can also be realized.

The system for carrying out the method can have the following elements:

The system for carrying out the method can include a cooler. The cooler cools a second warm water in a circuit within the water preparation plant.

The system for carrying out the method can include an exhaust gas condenser. In one configuration, the exhaust gas condenser is used to cool a third exhaust gas downstream of the heater. This results in condensation of steam from the third exhaust gas and water being recovered.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic of a first embodiment of a thermal water preparation plant;

FIG. 2 is a block diagram of second embodiment of a thermal water preparation plant;

FIG. 3 is a schematic of a water preparation plant.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

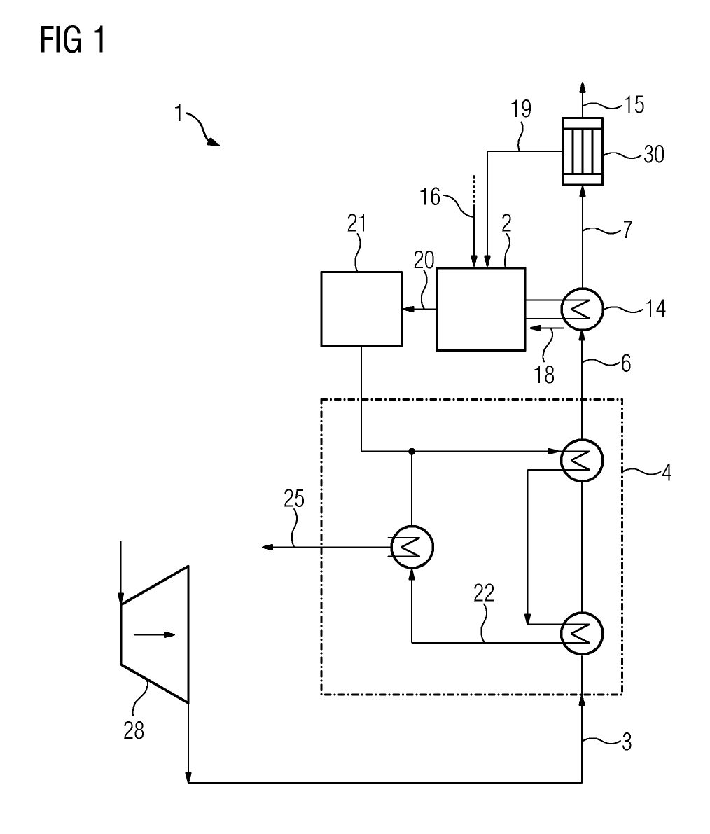

FIG. 1 shows a first exemplary embodiment for the operation of a thermal water preparation plant 2 for STIG concepts. A gas turbine 28 generates first exhaust gas 3 which is directed to a waste heat steam generator 4. Steam 22 generated using the waste heat steam generator 4 can then for example be used as heat 25 or given off directly as end product. The waste heat steam generator 4 uses process water 20 from the water preparation plant 2, which is for example stored in a tank 21, to obtain the steam 22. Second exhaust gas 6, which after the waste heat steam generator 4 is at a low temperature in the range from 70° C. to 250° C., is transported to a heater 14. In particular, the heater 14 can take the form of a heat exchanger. In this exemplary embodiment, the heater 14 is used in particular to prepare untreated water 16 in the water preparation plant 2 to give process water 20. In particular, this can involve de-ionizing the process water 20. By cooling the second exhaust gas 6 in the heater 14 to give the third exhaust gas 7, steam can be condensed to give a first condensation water 18. In this example, the first condensation water 18 is prepared in the water preparation plant 2 to give additional process water 20. After the heater 14, the cooled third exhaust gas 7 can still contain some steam. In order to also recover this water, the third exhaust gas 7 is directed to an exhaust gas condenser 30. In the exhaust gas condenser 30, more water then condenses to give a second condensation water 19, which is in turn prepared in the water preparation plant 2 to give process water 20. The process water 20 is then for example stored on-site in a tank 21 for later use. The third exhaust gas 7 then leaves the exhaust gas condenser 30 as further cooled and dried fourth exhaust gas 15.

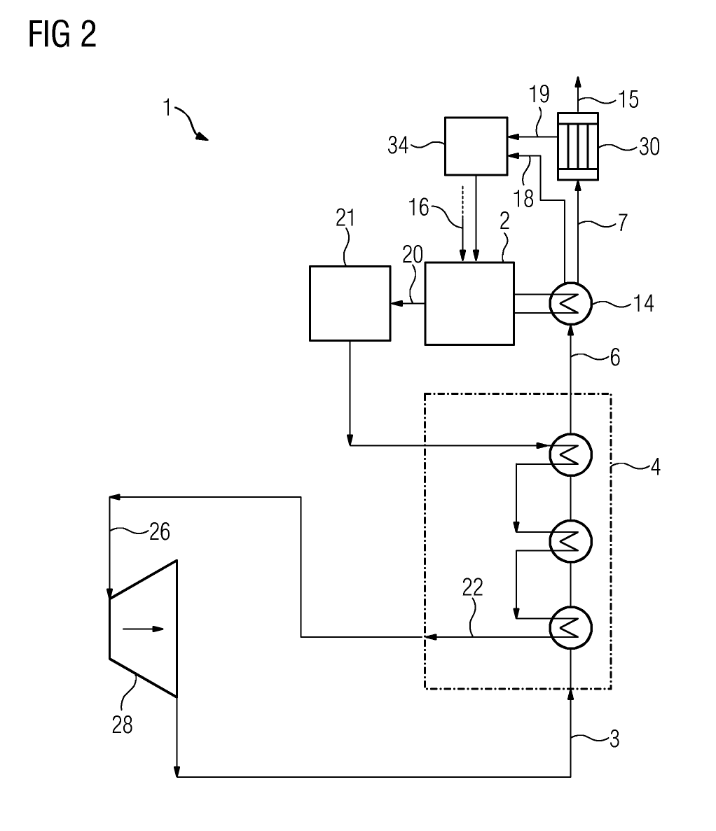

FIG. 2 shows a second exemplary embodiment which, in particular in the case of high demand for current, leads to a rapid increase in the power of the gas turbine 28. The setup shown in FIG. 2 also has the water preparation plant 2, the gas turbine 28, the waste heat steam generator 4, the heater 14, the exhaust gas condenser 30 and the tank 21. Here, steam 22 from the waste heat steam generator 4 is used for steam injection 26 into the gas turbine 28. In this case, the steam 22 is generated by the waste heat steam generator 4 from the process water 20 which is stored in the tank 21 and, according to the embodiment shown in FIG. 1, was obtained during low demand for current. The steam injection 26 causes an increase in the power of the gas turbine 28 and thus more current is generated. Furthermore, the steam injection 26 increases the water fraction in the first exhaust gas 3 downstream of the gas turbine 28 and consequently also in the second exhaust gas 6, and possibly also in the third exhaust gas 7. This leads to a significantly increased generation of first and possibly also of second condensation water 18, 19, which can be prepared in the water preparation plant 2 to give process water 20. Operation of the water preparation plant 2 uses the heat of the heater 14 which in turn uses the heat of the second exhaust gas 6 downstream of the waste heat steam generator 4. By recovering, from the second and third exhaust gas 6, 7, the process water 20 injected in the steam injection 26, and by preparing it in the water preparation plant 2, it is possible to fully cover the water requirements of the steam injection 26. In addition, the heat requirements of the water preparation plant 2 are covered by the heat supplied to the water preparation plant 2 by the heater 14. In addition to FIG. 1, FIG. 2 shows a treatment plant 34 for cleaning or preparing or treating the first or second condensation water 18, 19 of volatile or other materials. This can be necessary to clean the steam, injected into the gas turbine 28 by the steam injection 26, of for example inorganic and organic acids. A further possibility (not shown) is to treat the process water 20 in a treatment plant, which takes place before this water is fed into the waste heat steam generator 4. In addition, simultaneous treatment before and after the water preparation plant 2 may be used.

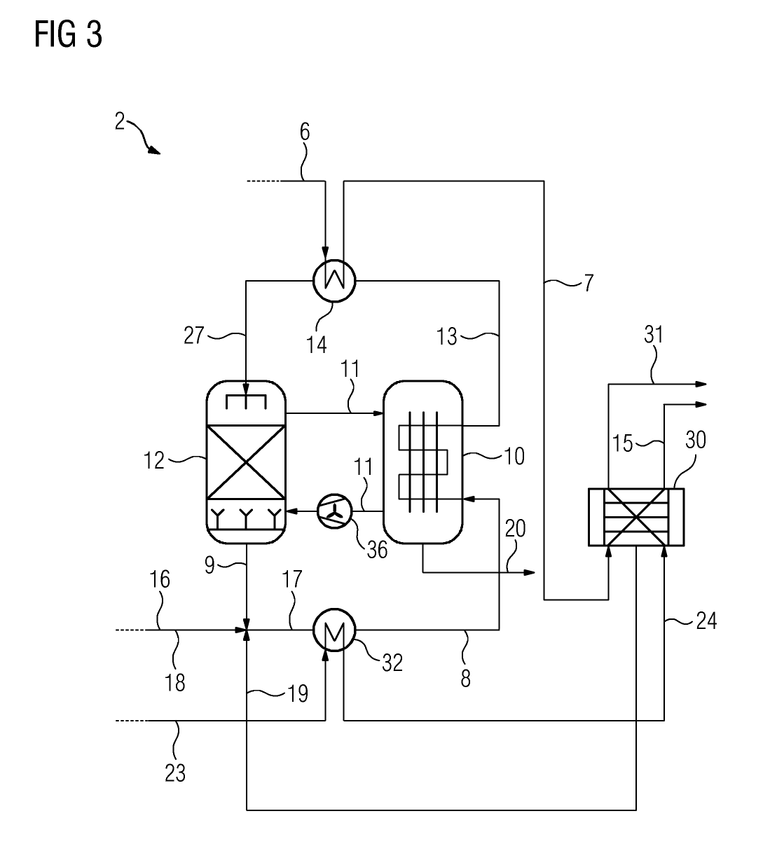

FIG. 3 shows a schematic representation of the water preparation plant 2 in which untreated water 16 or first or second condensation water 18, 19 is prepared to give process water 20. A first warm water 13, which is heated by the heater 14, wherein the heater 14 uses the heat of the second exhaust gas 6, is in a circuit between the condenser 10 and the vaporizer 12. In this exemplary embodiment, the water preparation plant 2 is operated according to the principle of convection-supported vaporization of water in a vaporizer 12 in counter-flowing air 11 combined with water-cooled condensers 10 for condensing out the clean process water 20. In addition, it is possible for the vaporization heat to be recovered. The air 11 circulates with the support of a fan 36. In the water preparation plant 2, cold water 8 is used as cooling water in the condenser 10, wherein process water 20 condenses out and the cooling water heats up. The heated cooling water, which now corresponds to the first warm water 13, is then further heated by the heater 14 to give heated water 27, and is then trickled in the vaporizer 12. The temperature of the downward-flowing water drops from the top to the bottom of the vaporizer 12 because heat is extracted by vaporization and by transfer of heat to the air 11. By contrast, the temperature of the counter-flowing air 11 increases from the bottom to the top of the vaporizer 12. First warm water 13, heated by the heater 14, and counter-flowing air 11 thus form in this exemplary embodiment a counter-flow heat exchanger, in that the heat of the second exhaust gas 6 and the low temperature of the latter, in the range between 70° C. and 250° C., can be used optimally. In order to permit permanent operation, the heated water 9 which collects at the bottom of the vaporizer 12 and which can in turn be mixed with untreated water 16, first condensation water 18 or second condensation water 19 to give a second warm water 17, can be cooled to give a cold water 8 prior to further use in the condenser 10. The second warm water 17 is cooled by a cooler 32 which uses cooling water 23. In addition, the cooling water 23 can be used as coolant 24 in the exhaust gas condenser 30. In the exhaust gas condenser 30, the third exhaust gas 7 further cooled after the heater 14 is brought to the point of condensing out second condensation water 19. The third exhaust gas 7 and the coolant 24 then leave the exhaust gas condenser 30 as further cooled and dried fourth exhaust gas 15 and third coolant 31. The exhaust gas condenser 30 can also be operated with a further coolant source (not shown here), in particular with a second cooling water. It is also possible for the cooling water 23 to be first used in the exhaust gas condenser 30, for condensing the second condensation water 19, before it is directed for cooling in the cooler 32.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A method for operating a gas turbine plant in combination with a thermal water preparation plant, comprising:
generating a first exhaust gas using the gas turbine plant;
cooling the first exhaust gas using a waste heat steam generator to produce a second exhaust gas at a temperature of 70° C. to 250° C.;
supplying first warm water from a condenser to a vaporizer within the thermal water preparation plant;
feeding the second exhaust gas to a heater to exchange heat in the second exhaust gas to the first warm water;
circulating air by a fan from the condenser to the vaporizer and back to the condenser; and
exchanging heat of the first warm water, heated by the heater, and the air in counter-flow within the vaporizer.

15. The method as claimed in claim 14, further comprising cooling second warm water using a first coolant, the second warm water becoming cold water.

16. The method as claimed in claim 15, further comprising cooling a third exhaust gas downstream of the heater in an exhaust gas condenser using the first coolant.

17. The method as claimed in claim 15, further comprising cooling a third exhaust gas downstream of the heater in an exhaust gas condenser using a second coolant.

18. The method as claimed in claim 17, further comprising cooling the second warm water in the cooler using the second coolant.

19. The method as claimed in claim 14, further comprising preparing at least one of untreated water, first condensation water from the heater, and second condensation water from the exhaust gas condenser in the thermal water preparation plant to obtain process water.

20. The method as claimed in claim 19, wherein at least part of the process water of the thermal water preparation plant is used to generate steam in the waste heat steam generator.

21. The method as claimed in claim 19, wherein at least part of the steam is recirculated for steam injection into the gas turbine plant.

22. The method as claimed in claim 19, wherein at least one of the first and second condensation water is cleaned of volatile materials prior to the preparation in the thermal water preparation plant.

23. The method as claimed in claim 19, further comprising carrying out at least one of condensation in the condenser and vaporization in the vaporizer in multiple stages.

24. A system for operating a gas turbine plant in combination with a thermal water preparation plant, comprising:
a steam injector in the gas turbine plant generating a first exhaust gas;
a waste heat steam generator cooling the first exhaust gas to produce a second exhaust gas at a temperature of between 70° C. and 250° C.;
at least one condenser and vaporizer in the thermal water preparation plant;
a heater exchanging heat from the second exhaust gas to first warm water of the thermal water preparation plant, the first warm water circulating through the thermal water preparation plant between the condenser and the vaporizer;
a fan circulating air from the condenser to the vaporizer and back to the condenser; and
a counter-flow heat exchanger formed by the first warm water, heated by the heater, and the air within the vaporizer.

25. The system as claimed in claim 24, further comprising a cooler.

26. The system as claimed in claim 24, further comprising an exhaust gas condenser.
